(19) United States
(12) Patent Application Publication
(10) Pub. No.: US 2007/0239455 A1
(43) Pub. Date: Oct. 11, 2007

(54) METHOD AND SYSTEM FOR MANAGING PRONUNCIATION DICTIONARIES IN A SPEECH APPLICATION

(75) Inventors: Michael E. Groble, Lake Zurich, IL (US); Changxue C. Ma, Barrington, IL (US)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/278,983

(22) Filed: Apr. 7, 2006

(51) Int. Cl. G10L 13/08

(52) U.S. Cl. 704/260

(57) ABSTRACT

A voice toolkit (100) and a method (700) for managing pronunciation dictionaries are provided. The visual toolkit can include a user-interface (110) for entering in a text and a corresponding spoken utterance, a text-to-speech system (120) for synthesizing a pronunciation from the text, a talking speech recognizer (132) for generating pronunciations of the spoken utterance, and a voice processor (130) for validating at least one pronunciation. A developer can type a text of a word into the toolkit and listen to the pronunciation to determine whether the pronunciation is acceptable. If the pronunciation is incorrect the developer can speak the word for providing a spoken utterance having a correct pronunciation.

### FIELD OF THE INVENTION

The embodiments herein relate generally to developing user interfaces and more particularly to developing speech interface applications.

### BACKGROUND

Speech interfaces allow people to communicate with computer systems or software applications using voice. A user can speak to the speech interface, and a person can also receive voice responses from the speech interface. The speech interface generally connects to a back end server for processing the voice and engaging voice dialogue. Depending on the application, the speech interface can be configured to recognize certain voice commands, and to respond to those voice commands accordingly. In practice, a speech interface may audibly present a list of voice commands which the user can select for interacting with the speech interface. The speech interface can recognize the responses in view of the list of voice commands presented, or based on a programmed response structure. During development, the developer selects a list of words that will be converted to speech for providing dialogue with the user. The words are generally synthesized into speech for presentation to the user. For example, within an interactive voice response (IVR) system, a user may be prompted with a list of spoken menu items. The menu items generally correspond to a list of items a developer has previously selected based on the IVR application.

Developing and designing a high level interaction speech interface can pose challenges. Developers of such systems can be responsible for designing voice prompts, grammars, and voice interaction. During development of the speech interface, a developer can define grammars to enumerate the words and phrases that will be recognized by the system. Speech recognition systems do not currently recognize arbitrary speech with high accuracy. Focused grammars increase the robustness of the speech recognition system. The speech recognizer generally accesses a vocabulary of pronunciations for determining how to recognize speech from the user. Developers typically have access to a large pronunciation dictionary from which they can build such vocabularies. However, these predefined dictionaries frequently do not provide coverage of all the terms the developer wishes to make available within the interface. This is especially true for entity names and jargon terms which are constantly being added to the language. Recognition may not always perform as expected for these out-of-vocabulary words, and the developer is not generally a linguist or speech recognition expert and does not generally have the expertise to create correct pronunciations for words that are not already in a master dictionary.

Similarly, the words can be synthesized into speech for presentation as a voice prompt, a menu or dialogue. In general, developers typically represent prompt and grammar elements as text items. The text items can be converted to synthesized speech using a text-to-speech system. Certain words may not lend well to synthesis; that is, a speech synthesis system may have difficulty enunciating words based on their lexicographic representation. Accordingly, the speech synthesis system can be expected to have difficulty in accurately synthesizing speech. The poorly synthesized speech may be presented to a person using the speech interface. A person engaging in voice dialogue with the speech interface may become frustrated with the artificial speech.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 illustrates a schematic of a system for developing a voice dialogue application in accordance with an embodiment of the inventive arrangements;

FIG. 2 illustrates a more detailed schematic of the system in FIG. 1 in accordance with an embodiment of the inventive arrangements;

FIG. 3 illustrates a grammar editor for annotating pronunciations in accordance with an embodiment of the inventive arrangements;

FIG. 4 illustrates a pop-up for presenting pronunciations in accordance with an embodiment of the inventive arrangements;

FIG. 5 illustrates a menu option in accordance with an embodiment of the inventive arrangements;

FIG. 6 illustrates a prompt to add pronunciations in accordance with an embodiment of the inventive arrangements; and

FIG. 7 illustrates a method for managing pronunciation dictionaries in accordance with an embodiment of the inventive arrangements.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “suppressing” can be defined as reducing or removing, either partially or completely. The term “processing” can be defined as number of suitable processors, controllers, units, or the like that carry out a pre-programmed or programmed set of instructions.

The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

The embodiments of the invention concern a system and method for managing pronunciation dictionaries during the development of voice dialogue applications. The system can include a user-interface for entering a text and a corresponding spoken utterance of a word, a text-to-speech unit for converting the text to a synthesized pronunciation, and a voice processor for validating the synthesized pronunciation in view of the text and the spoken utterance. The text-to-speech unit can include a letter-to-sound system for synthesizing a list of pronunciation candidates from the text. The voice processor can include a speech recognition system for mapping portions of the text to portions of the spoken utterance for identifying and updating phonetic sequences. The voice processor can translate the phonetic sequence to an orthographic representation for storage in a pronunciation dictionary. The pronunciation dictionary can store one or more pronunciations of words and spoken utterances.

The user-interface can include a grammar editor for adding and annotating words and spoken utterances. The user-interface can automatically identify whether a word entered in the grammar editor is in a pronunciation dictionary. If not, one or more pronunciations of the word can be entered in the pronunciation dictionary. If so, the pronunciation of the word can be validated. The user-interface editor can present a pop-up for showing multiple pronunciations of a confusable word entered in the grammar editor. In one aspect, the pronunciation can be represented as a phoneme sequence which can be audibly played by clicking on the pronunciation in the pop-up.

The user-interface can also include a prompt for adding a pronunciation to one or more pronunciation dictionaries. The prompt can include a dictionary selector for selecting a pronunciation dictionary, a recording unit for recording a pronunciation of a spoken utterance, a pronunciation field for visually presenting a phonetic representation of the pronunciation, and an add button for adding the pronunciation to the pronunciation dictionary.

Embodiments of the invention also concern a voice toolkit for managing pronunciation dictionaries. The voice toolkit can include a user-interface for entering in a text and a corresponding spoken utterance, a talking speech recognizer for generating pronunciations of the spoken utterance, and a voice processor for validating at least one pronunciation by mapping the text and the spoken utterance for producing at least one pronunciation. The user-interface can add the validated pronunciation to the dictionaries. The talking speech recognizer can synthesize a pronunciation of a recognized phonetic sequence.

Embodiments of the invention also concern a method for developing a voice dialogue application. The method can include entering in a text of a word, producing a list of pronunciation candidates from the text, and validating a pronunciation candidate corresponding to the word. A pronunciation candidate can be produced by synthesizing one or more letters of the text. The validation can include receiving a spoken utterance of the word, and comparing the spoken utterance to the pronunciation candidates. A pronunciation dictionary can provide pronunciations based on the text and the spoken utterance. For example, a developer of the voice dialogue application can provide a spoken utterance to exemplify a pronunciation of the text. The pronunciation can be compared with the pronunciation candidates provided by the dictionary. The comparison can include comparing waveforms of the pronunciations, or comparing a text representation of the spoken utterance with a text representation of the pronunciation candidates.

In one aspect, a confusability of the word can be calculated for one or more grammars in the pronunciation dictionary. Visual feedback can be provided for one or more words in the pronunciation dictionary that are confusable with the word. A branch can be included in a grammar to suppress confusability of the word if the confusability of the word with another word of the grammar exceeds a threshold.

Embodiments of the invention concern a method and system for managing pronunciation dictionaries during development of a voice dialogue application. A pronunciation dictionary can include one or more phonetic representations of a word which describe the pronunciation of the word. The system can audibly play pronunciations for allowing a developer of the voice application to hear the pronunciation of an entered word. For example, a developer can type a text of a word and listen to the pronunciation. The developer can listen to the pronunciation to determine whether the pronunciation is acceptable.

Various pronunciations of the word can be selected during the development of the voice application. If a pronunciation is incorrect the developer can speak the word for providing a spoken utterance having a correct pronunciation. The system can recognize a phonetic spelling from the spoken utterance, and the phonetic spelling can be added to a pronunciation dictionary. The expanded pronunciation dictionary can help the developer build grammars that the system can correctly identify when interfacing with a user. The system can identify discrepancies between the pronunciations and update or add a pronunciation to the dictionary in accordance with the correct pronunciation. Understandably, a developer can manage pronunciation dictionaries during development of a voice application for ensuring that a user of the voice application hears a correct pronunciation of one or more words used within the voice dialogue application. The expanded pronunciations also allow the voice dialogue application to more effectively recognize words spoken by users of the application having a similar pronunciation.

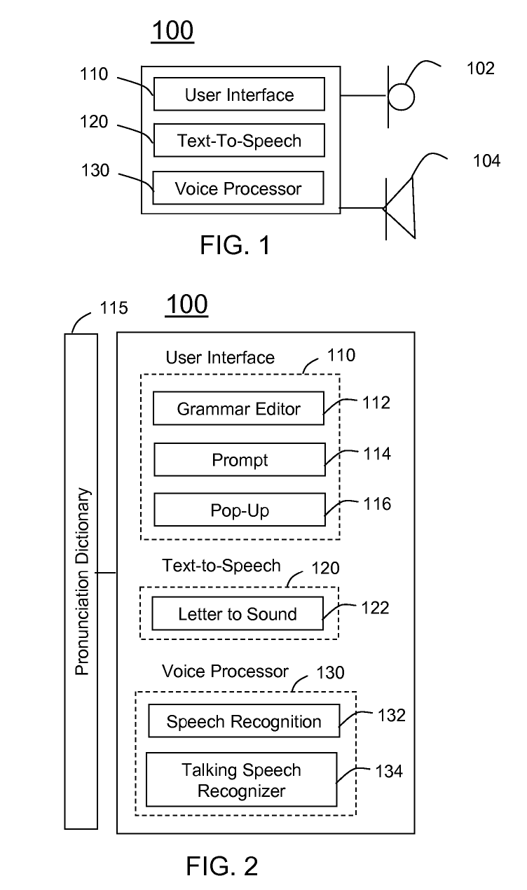

Referring to FIG. 1, a system 100 for developing voice dialogue applications is shown. The system 100 can be a software program, a program module to an integrated development environment (IDE), or a standalone software application, though is not herein limited to these. In one embodiment the system 100 can include a user-interface 110 for entering a text and a corresponding spoken utterance of a word, a text-to-speech unit 120 for converting the text to a synthesized pronunciation, and a voice processor 130 for validating the synthesized pronunciation in view of the text and the spoken utterance. A microphone 102 and a speaker 104 are presented for purposes of illustration, though are not necessarily part of the inventive aspects.

A developer can type a word into the user-interface 110 during development of a voice dialogue application. For example, the word can correspond to a voice tag, voice command, or voice prompt that will be played during execution of the voice dialogue application. During development, the text-to-speech unit 120 can synthesize a pronunciation of the word from the text. The developer can listen to the synthesized pronunciation to determine whether it is an accurate pronunciation of the word. If it is an accurate pronunciation, the developer can accept the pronunciation. If it is an inaccurate pronunciation, the developer can submit a spoken utterance of the word for providing a correct pronunciation.

For example, the developer can say the word into the microphone 102. The voice processor 130 can evaluate discrepancies between the submitted spoken utterance and the inaccurate pronunciation for updating the pronunciation or adding a new pronunciation. The voice processor 130 can validate the spoken utterance in view of the text for ensuring that the pronunciation is a correct representation. The voice processor 130 can play the updated or new pronunciation, through the speaker 104. Again, the developer can listen to the new pronunciation and determine whether it is accurate and proceed with development accordingly.

A developer of a voice dialogue application can employ the system 100 for identifying and selecting words to be used in a voice dialogue application. In one aspect, a voice dialogue application can communicate voice prompts to a user and receive voice replies from a user. A voice dialogue application can also recognize voice commands and respond accordingly. For example, a voice dialogue application can be deployed within an Interactive Voice Response (IVR) system, within a VXML program, within a mobile device, or within any other suitable communication system. For example, within an IVR, a user can call a bank for financial services and interact with the IVR for inquiring financial status. A caller can submit spoken requests which the IVR can recognize, process, and respond. The IVR can recognize voice commands from the caller, and/or the IVR can present voice prompts to the caller. The IVR may interface to a VXML program which can process speech-to-text and text-to-speech. The developer can communicate voice prompts through text programming in XML. The VXML program can reference speech recognition and text-to-speech synthesis systems for coordinating and engaging voice dialogue. In general, whether IVR or VXML, voice prompts are presented to a user for allowing a user to listen to a menu and vocalize a selection. A user can submit a voice command corresponding to a selection on the menu. The IVR or VXML program can recognize the selection and route the user to an appropriate handling application.

Referring to FIG. 2, a more detailed schematic of the system 100 is shown. In particular, components of the user-interface 110, the text-to-speech unit 120, and the voice processor 130 are shown. The user-interface 110 can include a grammar editor 112 for adding and annotating words, a prompt 114 for adding a pronunciation to a pronunciation dictionary 115, and a pop-up 116 for showing multiple pronunciations of a confusable word entered in the grammar editor 112. The text-to-speech unit 120 can include a letter-to-sound system 122 for synthesizing a list of pronunciation candidates from the text. The voice processor 130 can include a speech recognition system 132 for recognizing and updating a phonetic sequence of the spoken utterance, and a talking speech recognizer 134 for validating at least one pronunciation. In one aspect, the voice processor 130 can map the text to the spoken utterance for producing at least one pronunciation. The speech recognition system 132 can generate a phonetic sequence of the spoken utterance. And, the talking speech recognizer can translate the phonetic sequence to an orthographic representation for storage in a pronunciation dictionary. The speech recognition system 132 can be a part of the talking speech recognizer 134, but is not limited to performing as a separate component. The speech recognition system 132 and the speech recognizer 134 are presented as separate elements for describing distinguishing functionalities.

In practice, a developer represents prompt and grammar elements orthographically as text items. An orthographic representation is a correct spelling of a word. The developer can enter the text of the word to be used in a prompt in the grammar editor 112. Separate pronunciation dictionaries 115 exist to map the orthographic representation of the text to phone sequences for both recognition and synthesis. For example, once the developer enters the text, the text-to-speech 120 can convert the text to a phonetic sequence by examining the text and comparing the text to entries in the pronunciation dictionaries 115. In one arrangement, the dictionaries 115 can be phonetic based dictionaries that map letters to phonemes. The letter-to-sound unit 122 can identify one or more letters in the text that correspond to phoneme in a pronunciation dictionary 115. The letter-to-sound unit 122 can also recognize sequences and combinations of phonemes from words and phrases. Notably, the pronunciation can be represented as a sequence of symbols, such as phonemes or other characters, which can be interpreted by a synthesis engine for producing audible speech. For example, the talking speech recognizer 134 can synthesize speech from symbolic representation of the pronunciation.

When a developer enters a text into the grammar editor 112, the grammar editor can identify whether the word is already included in a pronunciation dictionary 115. Referring to FIG. 3, an example of an annotation 310 for an unrecognized word typed into the grammar editor 112 is shown. The grammar editor 112 can determine that the typed word is not included in the pronunciation dictionary 115, and is an out-of-vocabulary word. The illustration in FIG. 3 shows the annotation 310 for the text “Motorola” which is eclipsed with a hovering warning window 320 revealing the reason for the warning. The warning can state that the submitted text does not correspond to a pronunciation in the dictionary 115. Also, a yellow warning index 330 is shown in the left or right margin indicating the location of the out-of-vocabulary word.

The same mechanism for reporting an out-of-vocabulary word can also be used to identify words that are confusable within the same grammar branch. For example, the dictionaries 115 include grammars which provide rules for interpreting the text and forming pronunciations. The text of a submitted word may be confusable with another word in the pronunciation dictionary. Accordingly, the user-interface 110 can prompt the developer that multiple pronunciations exist for a confusable word.

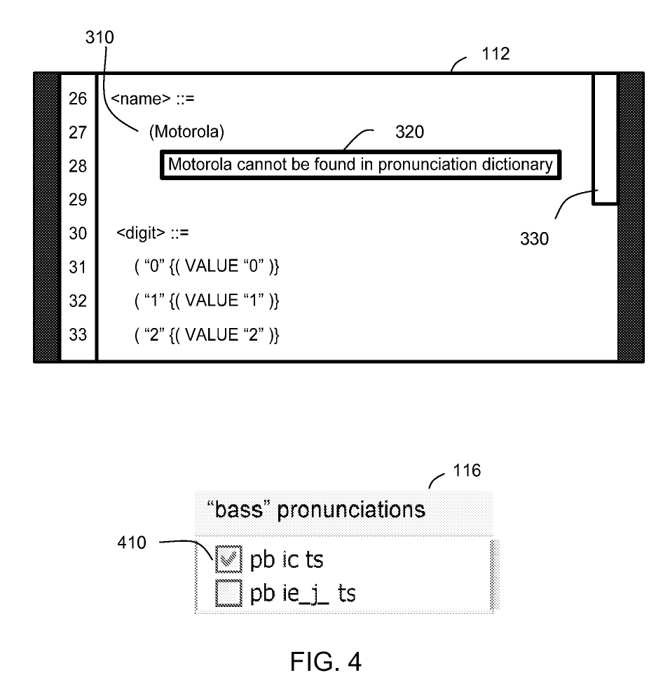

If the word is in a pronunciation dictionary 115, the user-interface 110 can present a pop-up 116 containing a list of available pronunciations. For example, referring to FIG. 4, the developer may type in the word “bass” to the grammar editor 112. The word “bass” can have two pronunciations. The grammar editor 112 can determine that one or more pronunciations for the word exist in the pronunciation dictionaries 115. If one or more pronunciations exist, the user-interface 110 presents the pop-up 116 showing the pronunciations available to the developer. In one arrangement, the developer can select a pronunciation by single clicking, or double clicking the selection 410. Upon, making the selection 410, the pronunciation will be associated with the word used in the voice dialogue application. A user of the voice dialogue application will then hear a pronunciation corresponding to the selection chosen by the developer.

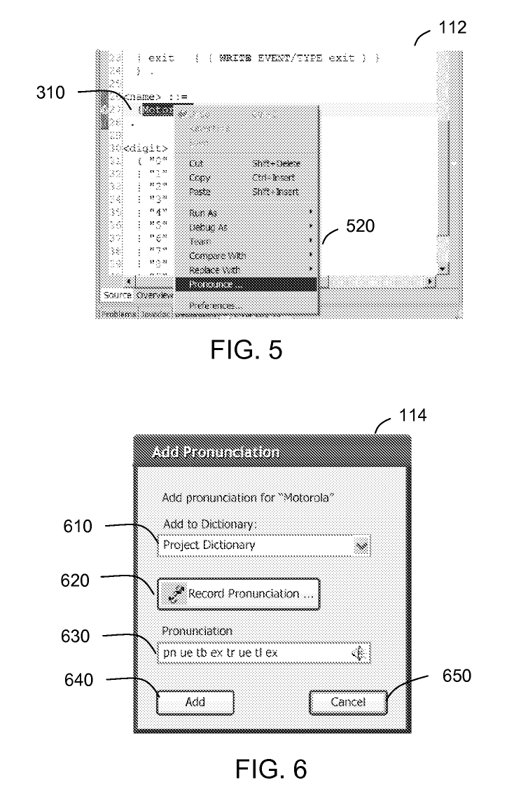

In certain cases, the developer may submit text, or terms, that do not have a corresponding pronunciation in the dictionary. When the designer uses text, or terms, that are not in the dictionaries, the text-to-speech system 120 of FIG. 2 enlists the letter-to-sound system to produce the pronunciation from letters of the text. Consequently, an unrecognized text may be synthesized using only the letters of the text which can result in the generation of artificially sounding speech. The developer can listen to the synthesized speech from within the grammar editor 112. Referring to FIG. 5, the grammar editor 112 can provide a menu option 520 for a developer to hear the pronunciation of the entered text. For example, the menu 520 can provide options for listening to the pronunciation of the text 310. As noted, a recognized pronunciation will sound less artificial than a non-recognized pronunciation. A non-recognized pronunciation is generally synthesized using only the letter-to-sound system which can introduce discontinuities or artificial nuances in the synthesized speech. A recognized pronunciation can be based on the combination and relationship between one or more letters in the text and which results in less artificial sounding speech.

Upon listening to the production, the developer can determine whether the pronunciation is acceptable. For example, the developer may be dissatisfied with the pronunciation of the synthesized word. Accordingly, the developer can submit a spoken utterance to provide an example of a correct pronunciation. For example, though not shown, the developer can select an “Add Pronunciation” from the voice menu 520. In response, the grammar editor 112 can present a prompt 114 for allowing the developer to submit a spoken utterance. For example, referring to FIG. 6, an “Add Pronunciation” prompt 114 is shown. The prompt 114 can include a dictionary selector 610 for selecting a pronunciation dictionary, a recording unit 620 for recording a pronunciation of a spoken utterance, a pronunciation field 630 for visually presenting a phonetic representation of the pronunciation, and an add button 640 for adding the pronunciation to the pronunciation dictionary. The developer can also cancel the operation using cancel button 650.

Upon depressing the record pronunciation button 620, the developer can submit a spoken utterance which can be captured by the microphone 102 of FIG. 1. The utterance can be processed by the voice processor 130. The voice processor 130 can translate the waveform of the spoken utterance to a phonetic spelling. The voice processor 130 can also validate a pronunciation of the spoken utterance by comparing the spoken phonetic spelling with a phonetic representation of the submitted text. For example, the user would speak the word as it is intended to be pronounced. The system would use the orthographic representation and the recorded sound to recognize the phone sequence that was spoken. It should be noted that the voice processor 130 can convert the spoken utterance to a phonetic spelling without reference to the submitted text. The comparison is an additional step for validating a correct interpretation of the phonetic spelling from the spoken utterance. Comparing the phonetic sequence of the spoken utterance to a phonetic interpretation of the submitted text is an optional step for verifying a recognition of the phonetic sequence. The speech recognition system 132 within the voice processor 130 of FIG. 2 can present a visual representation of the determined pronunciation in the pronunciation field 630. For example, the pronunciation of “Motorola” can correspond to a dictionary entry of “pn eu tb ex tr ue tl ex” if correctly spoken and recognized.

If a pronunciation for the recognized spoken utterance does not exist in the dictionary 115, the developer can add the pronunciation to the dictionary 115. If one or more pronunciations already exist in the dictionary for the recognized spoken utterance, the pop-up 116 can display the list of available pronunciations. The developer can select one of the existing pronunciations, or the developer can edit the pronunciation to create a new pronunciation. For example, the developer can type in the pronunciation field 630 to directly edit the pronunciation, or the user can articulate a new spoken utterance to emphasize certain aspects of the word. Understandably, the developer should be familiar with the language of the pronunciation to masterfully perform the edits. Expanding the pronunciation dictionary allows the speech recognition system 132 to interpret a wider variety of pronunciations when interfacing with a user. Understandably, the developer may submit a spoken utterance when the speech recognition system can not adequately recognize a word due to an improper pronunciation. Accordingly, the developer provides a pronunciation of the word to expand the pronunciation dictionary. This allows the speech recognition system 132 to recognize a pronunciation of the word when a user of the voice dialogue application interfaces using voice.

The developer can listen to the pronunciation of the spoken utterance to ensure the pronunciation is acceptable. Referring to FIG. 2, the speech recognition can generate a phonetic sequence from a recognized utterance and the talking speech recognizer 134 can synthesize the speech from the phonetic sequence. The talking speech recognizer 134 is a preferable alternative to using the text-to-speech 120 which requires a spelling of the spoken utterance in a text format. Understandably, speech recognition systems primarily attempt to capture a phonetic representation of the spoken utterance. They generally do not produce a correct text or spelling of the spoken utterance. The speech recognition system 132 generally produces a phonetic representation of the spoken utterance or some other phonetic model. The text-to-speech system 120 cannot adequately synthesize speech from a phonetic sequence. Accordingly, the voice processor 130 employs the talking speech recognizer 134 to synthesize pronunciations of spoken utterances provided by the developer.

Referring back to FIG. 2, the system 100 can be considered a voice toolkit for the development of speech interface applications. The visual toolkit provides an interface designer a development environment which manages global and project specific pronunciation dictionaries, provides visual feedback when interface elements are not found within existing dictionaries, provides a means for the designer to create new dictionary elements by voice, provides visual feedback when elements of the speech interface have multiple dictionary entries, provides a means for the designer to listen to the multiple matches and pick which pronunciations to allow in the end system, and provides visual feedback when words in the same grammar branch are confusable to the speech recognition system.

In one aspect, the visual toolkit 100 determines when the performance of the speech interface may degrade due to out-of-vocabulary words or to ambiguities in pronunciation. The ambiguities can occur due to multiple dictionary entries or to confusability of terms in the same branch of a grammar. The visual toolkit 100 provides direct feedback during the development process with regard to these concerns. In another aspect, the developer can submit spoken utterances for unacceptable pronunciations, and use the talking speech recognizer to validate the new pronunciations in the dictionaries.

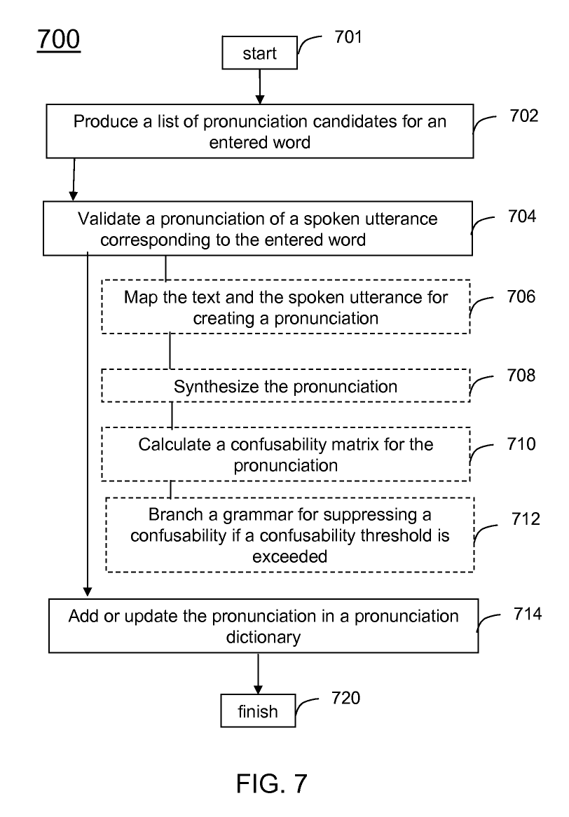

Referring to FIG. 7, a method 700 for managing pronunciation dictionaries during development of a voice dialogue application is shown. When describing the method 700, reference will be made to FIGS. 1 through 7, although it must be noted that the method 700 can be practiced in any other suitable system or device. The steps of the method 700 are not limited to the particular order in which they are presented in FIG. 7. The inventive method can also have a greater number of steps or a fewer number of steps than those shown in FIG. 7.

At step 701, the method can start in a state where a developer enters a text for creating a voice prompt. At step 702, a list of pronunciation candidates can be produced for the entered word. For example, referring to FIGS. 2 and 3, the developer can enter in the text to the grammar editor 112. The text-to-speech system 120 can identify whether one or more pronunciations exist within the dictionary 115. If a pronunciation exists, the text-to-speech system 120 can generate a synthesized pronunciation. Otherwise the letter-to-sound system 122 can synthesize a pronunciation from the letters of the entered text. The developer can listen to the synthesized pronunciations by selecting the pronunciation option in the prompt 520 of FIG. 5. The developer can determine whether the pronunciation is acceptable by listening to the pronunciation. If the pronunciation is unacceptable, the developer can submit a spoken utterance corresponding to a correct pronunciation of the text. For example, referring to FIG. 6, the developer can record a correct pronunciation by speaking into the microphone 102 of FIG. 1.

At step 704, a pronunciation of a spoken utterance corresponding to the text can be validated. Referring to FIG. 2, the voice processor can compare waveforms of the pronunciations, or compare a text representation of the spoken utterance with a text representation of the pronunciation candidates. The voice processor 130 can use the orthographic sequence of the entered text and the recorded spoken utterance to recognize the phone sequence that was spoken. The voice processor 130 can translate the phone sequence to a pronunciation stored as an orthographic representation of the phonetic sequence. For example, at step 706, the voice processor 130 can map portions of the text to portions of the spoken utterance for identifying phonemes. The speech recognition system 132 can generate a phonetic sequence, and the talking speech recognizer 134 at step 708 can convert the phonetic sequence to a synthesized pronunciation. The developer can listen to the pronunciation identified from the phonetic sequence.

At step 710, the voice processor can create a confusability matrix for the pronunciation with respect to pronunciations from one or more pronunciation dictionaries. In one example, a confusability matrix charts out numeric differences between the identified phonetic sequence of the recognized utterance and other phonetic sequences in the dictionaries. For example, a numeric confusability can be a phoneme distance, a spectral distortion distance, a statistical probability metric, or any other comparative method. If a confusability exists, the user-interface 110 can present a pop-up for identifying those pronunciations having similar phonetic structure or pronunciations. The pop-up can include a warning to indicate that the new pronunciation is confusable within its grammar branch. If the developer decides to keep the pronunciation of the spoken utterance, the user-interface 110, at step 712, can branch the grammar within the pronunciation dictionaries to include the new pronunciation and distinguish it from other existing pronunciations.

At step 714, a pronunciation of the spoken utterance corresponding to the text can be added or updated within a pronunciation dictionary. For example, referring to FIG. 2, the user-interface 110 can receive a confirmation from the developer through the prompt 114 or the pop-up 116 for accepting a new pronunciation or updating a pronunciation. The user-interface 110 can add or update the pronunciation in one or more of the pronunciation dictionaries 115.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments are not so limited. Numerous modifications, changes, variations, substitutions and equivalents will occur to those skilled in the art without departing from the spirit and scope of the present embodiments of the invention as defined by the appended claims.

What is claimed is:

1. A system for developing voice dialogue applications, comprising:
a user-interface for entering a text and a corresponding spoken utterance of a word;
a text-to-speech unit for converting said text to a synthesized pronunciation and for playing said synthesized pronunciation; and
a voice processor for validating said synthesized pronunciation in view of said text and said spoken utterance,
wherein said voice processor and said text-to-speech unit receive said text and said spoken utterance from said user-interface.

2. The system of claim 1, wherein said voice processor includes a speech recognition system for recognizing and updating a phonetic sequence of said spoken utterance by mapping portions of said text to portions of said spoken utterance for identifying phonetic sequences.

3. The system of claim 1, wherein said voice processor translates said phonetic sequence to an orthographic representation for storage in a pronunciation dictionary.

4. The system of claim 1, wherein said user-interface further comprises a grammar editor for adding and annotating words and spoken utterances.

5. The system of claim 4, wherein said user-interface automatically identifies whether a word entered in said grammar editor is included in a pronunciation dictionary, wherein said pronunciation dictionary stores one or more pronunciations of said words and said spoken utterances.

6. The system of claim 4, wherein said user-interface editor further includes a pop-up for showing multiple pronunciations of a confusable word entered in said grammar editor.

7. The system of claim 6, wherein a pronunciation is represented as a phoneme sequence, and said pronunciation is audibly played by clicking on said pronunciation in said pop-up.

8. The system of claim 4, wherein said user-interface further includes a prompt for adding a pronunciation to a pronunciation dictionary, said prompt comprising:
a dictionary selector for selecting a pronunciation dictionary;
a recording unit for recording a pronunciation of a spoken utterance;
a pronunciation field for visually presenting a phonetic representation of said pronunciation; and
an add button for adding said pronunciation to said pronunciation dictionary.

9. The system of claim 4, wherein said text-to-speech unit further includes a letter-to-sound system for synthesizing a list of pronunciation candidates.

10. A voice toolkit for managing pronunciation dictionaries, comprising:
a user-interface for entering in a text and a corresponding spoken utterance;
a talking speech recognizer for generating pronunciations of said spoken utterance; and
a voice processor for validating at least one pronunciation by mapping said text and said spoken utterance for producing at least one pronunciation,
wherein said user-interface adds said validated pronunciation to said pronunciation dictionaries.

11. A method for developing a voice dialogue application comprising:
entering in a text of a word;
producing a list of pronunciation candidates from said text; and
validating a pronunciation candidate corresponding to said word.

12. The method of claim 11, wherein said validating further comprises:
receiving a spoken utterance of said word; and
comparing spoken utterance to said pronunciation candidates,
wherein said comparing includes comparing a phonetic sequence of said spoken utterance to said pronunciations.

13. The method of claim 12, further comprising:
recognizing a phoneme sequence from said spoken utterance; and
formulating a pronunciation from said phoneme sequence.

14. The method of claim 13, further comprising:
visually displaying said phoneme sequence; and
audibly playing said pronunciation.

15. The method of claim 12, wherein said comparing identifies discrepancies in a synthesized phoneme sequence of said spoken utterance and a synthesized phoneme sequence of a pronunciation candidate.

16. The method of claim 11, wherein producing a pronunciation candidate includes synthesizing one or more letters of said text.

17. The method of claim 11, wherein said producing further comprises determining whether a pronunciation for said word exists in a pronunciation dictionary, and if not, adding a pronunciation of said word to said pronunciation dictionary, wherein said pronunciation is represented as a phoneme sequence, and if so, determining whether multiple pronunciations are found within said pronunciation dictionary.

18. The method of claim 17, further comprising identifying one or more pronunciation dictionaries for adding a pronunciation of said word, wherein contents of said pronunciation dictionaries are visually displayed.

19. The method of claim 17, further comprising identifying one or more pronunciations in a dictionary and presenting said pronunciations in a visual format.

20. The method of claim 11, further comprising
calculating a confusability of the word for one or more grammars in a pronunciation dictionary;
providing visual feedback for one or more words in a grammar that are confusable; and
branching said grammar to suppress confusability of said word if said confusability of said word with another word associated with said grammar exceeds a threshold.
